(19) United States
(12) Patent Application Publication
(10) Pub. No.: US 2013/0182362 A1
(43) Pub. Date: Jul. 18, 2013

(54) Protecting Unit Having a Function of Thermal Energy Guiding

(71) Applicant: Kuei-Chang Chen, Changhua City (TW)

(72) Inventor: Kuei-Chang Chen, Changhua City (TW)

(73) Assignee: Kuei-Chang Chen

(21) Appl. No.: 13/351,886

(22) Filed: Jan. 17, 2012

(51) Int. Cl. H02H 3/08

(52) U.S. Cl. 361/111

(57) ABSTRACT

A protecting unit having a function of thermal energy guiding comprises a body electrically connected to a first lead-out electrode and a second lead-out electrode; the body being wrapped in a packing material; a thermal energy guider disposed on the body adopting a continuous leading wire; one end of the leading wire being disposed on the first lead-out electrode, and the other end thereof being outward extended from the packing material. Thereby, the thermal energy guider utilizes thermal conduction to guide thermal energy in/out of the body so as to prevent electronic appliances from overloading and avert danger.

### 1. FIELD OF THE INVENTION

The present invention relates to a protecting unit for electronic appliances, especially to a protecting unit that is able to correctly and rapidly conduct thermal energy.

### 2. Description of the Related Art

There are many passive components designed for protecting electronic appliances such as the Voltage Dependent Resistor (VDR) or the Thermal Cut-Off (TCO). Wherein, the VDR is directed to a resistance for protecting excessive transient voltage. The most common VDR is the Metal Oxide Varistor (MOV). The protecting means is conducted as follows: When a power source provides normal voltage, the VDR is set in a high impedance module; oppositely, when the power source provides abnormal voltage and the voltage is too high, the VDR is rapidly turned into a low impedance module for the surge current to pass. Concurrently, the VDR generates heat to remove the abnormal energy so as to protect the vulnerable electronic appliances or circuits. Herein, when two ends of the VDR receive continuous voltage, the VDR becomes aging. Accordingly, the VDR gets tardy in heating, and the grain boundary structure thereof is ruined. As a result, the VDR breaks down. Moreover, the transient surge results in excessive current and overmuch energy that the VDR is unable to bear. Whereby, it is easily to be on fire or cause bursts.

In order to avoid danger caused by the malfunctioned VDR, the Thermal Cut-Off (TCO) is generally applied. Herein, the TCO is triggered by an alloy having low fusing point, and the TCO would not be timely triggered unless the contact means between the VDR and the TCO is superior. However, when the VDR would malfunction is mostly unpredictable, so there is usually little time to pass the thermal energy to the TCO; as a result, the VDR can not be efficiently protected. Fortunately, a connecting unit for tightly combining the VDR and the TCO is developed in the market, such as the Thermal Metal Oxide Varistor (TMOV). FIG. 1 shows a schematic view of a conventional TMOV. The principle is as follows: the VDR and the TCO are compactly combined for the heat to be conducted to the alloy that contains low fusing point in the TCO. FIGS. 2 and 3 show schematic views of the TCO before turned-on and after turned-on, respectively. Herein, by means of the surface tension and the particular material, the melting alloy that has low fusing point shrinks into a ball formation, and thereby the object of cutting off the current is achieved.

In order to rapidly trigger the TCO, the VDR and the TCO are usually packed together. Herein, the fusing point of the alloy is below 150° C. Moreover, in order to prevent the alloy having low fusing point from melting during packing, the epoxy resin that is preferably against moisture is unable to be applied since the epoxy resin easily solidifies in 150° C. and 1.5 hour. Further, when the TCO utilizes the surface tension and the particular material to allow the melting alloy that has low fusing point to shrink into a ball formation, the gravity and the placement easily make a part of the alloy remain, which adversely incurs electric leakage. Additionally, the material of the lead in the electronic appliances generally adopts the tin-plated copper wire. Nonetheless, the electric conductivity of the alloy that has low fusing point is 10% to 30% less than that of the tin-plated copper wire. As a result, if there is excessive current continuously provided or any transient surge current occuring, the different electric conductivity likely invites danger. Therefore, afore protecting unit needs some amendment.

### SUMMARY OF THE INVENTION

The object of the present invention is to provide a protecting unit having a function of thermal energy guiding to correctly and rapidly conduct thermal energy for protecting electronic appliances.

In order to accomplish the foregoing objects and goals, the protecting unit having a function of thermal energy guiding comprises a body electrically connected to a first lead-out electrode and a second lead-out electrode; a thermal energy guider being disposed on the first lead-out electrode; a packing material being disposed on the body and wrapping an appearance of the same; and the thermal energy guider penetrating and extended out of the packing material.

Thereby, the present invention utilizes the packing material to pack the body for preventing the body from aging and malfunctioning while the body contacts the exterior. Moreover, the packing material is same as that adopted in the existing electronic ceramic units, so the packing material would not be changed. Thus, the thermal energy guider utilizes the thermal conduction to guide thermal energy in/out of the body so as to prevent electronic appliances from overloading and avert danger.

### BRIEF DESCRIPTION OF THE DRAWINGS

FIG. 1 is a schematic view showing a conventional Thermal Metal Oxide Varistor (TMOV);

FIG. 2 is a schematic view showing the conventional TMOV before started;

FIG. 3 is a schematic view showing the conventional TMOV after started;

FIG. 4 is a schematic view showing structures of a first preferred embodiment of the present invention;

FIG. 5 is a front view showing the first preferred embodiment of the present invention;

FIG. 6 is a back view showing the first preferred embodiment of the present invention;

FIG. 7 is a schematic view showing structures of a second preferred embodiment of the present invention; and

FIG. 8 is a schematic view showing the current being cut off in the second preferred embodiment of the present invention.

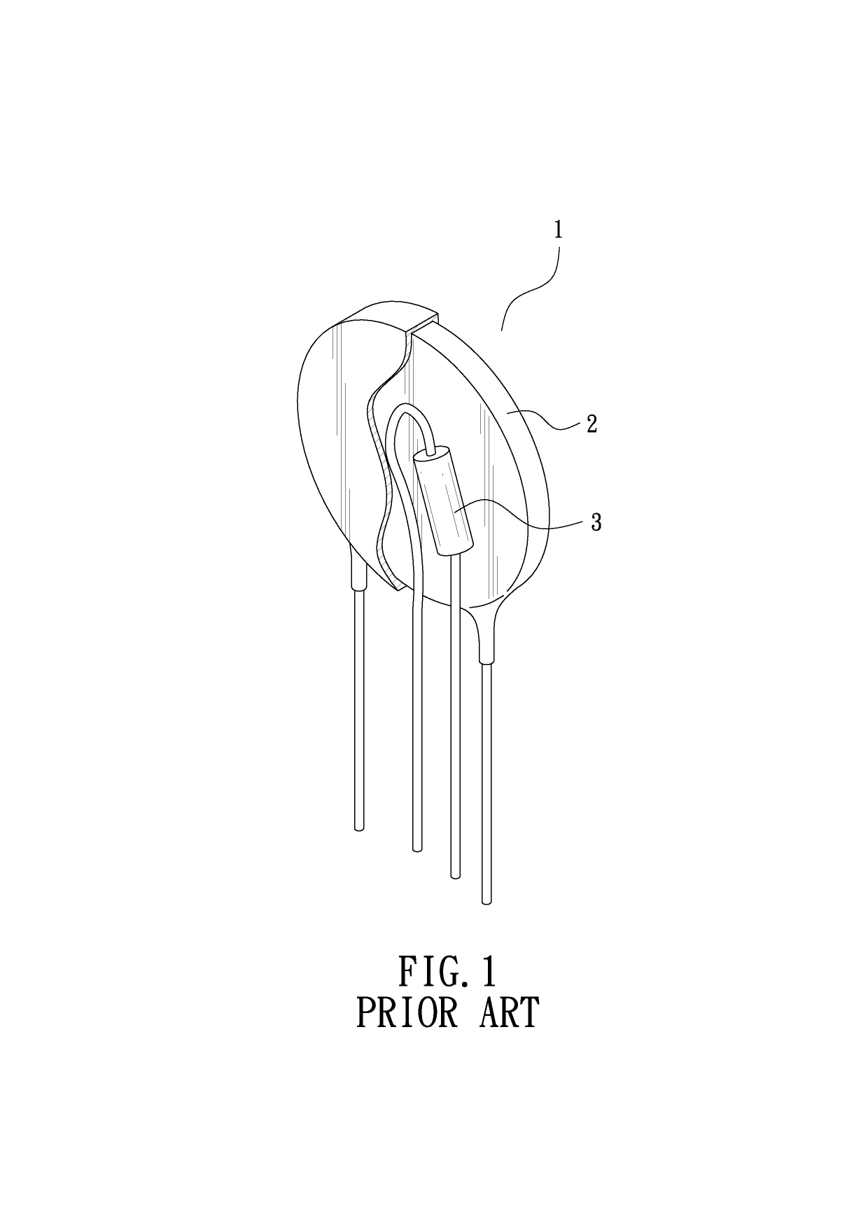

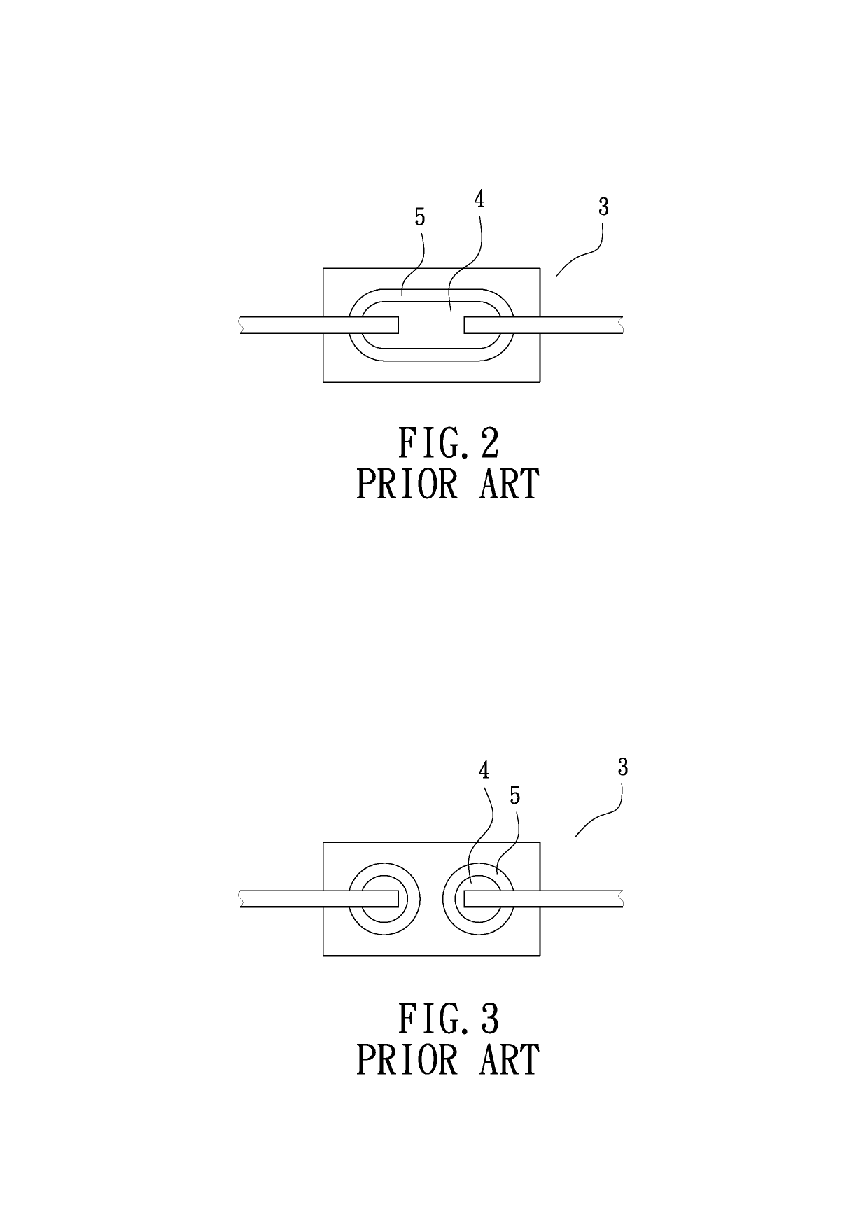

### DETAILED DESCRIPTION OF THE PREFERRED EMBODIMENTS

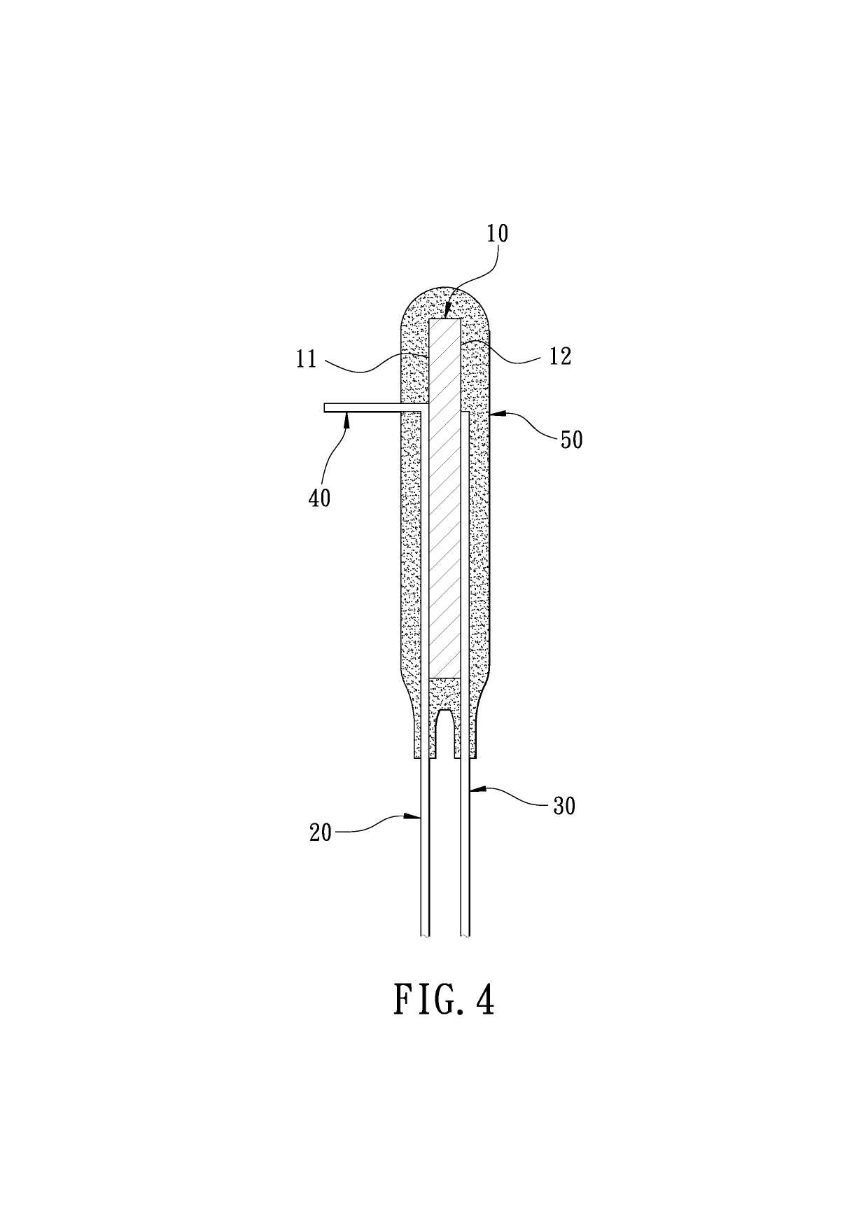

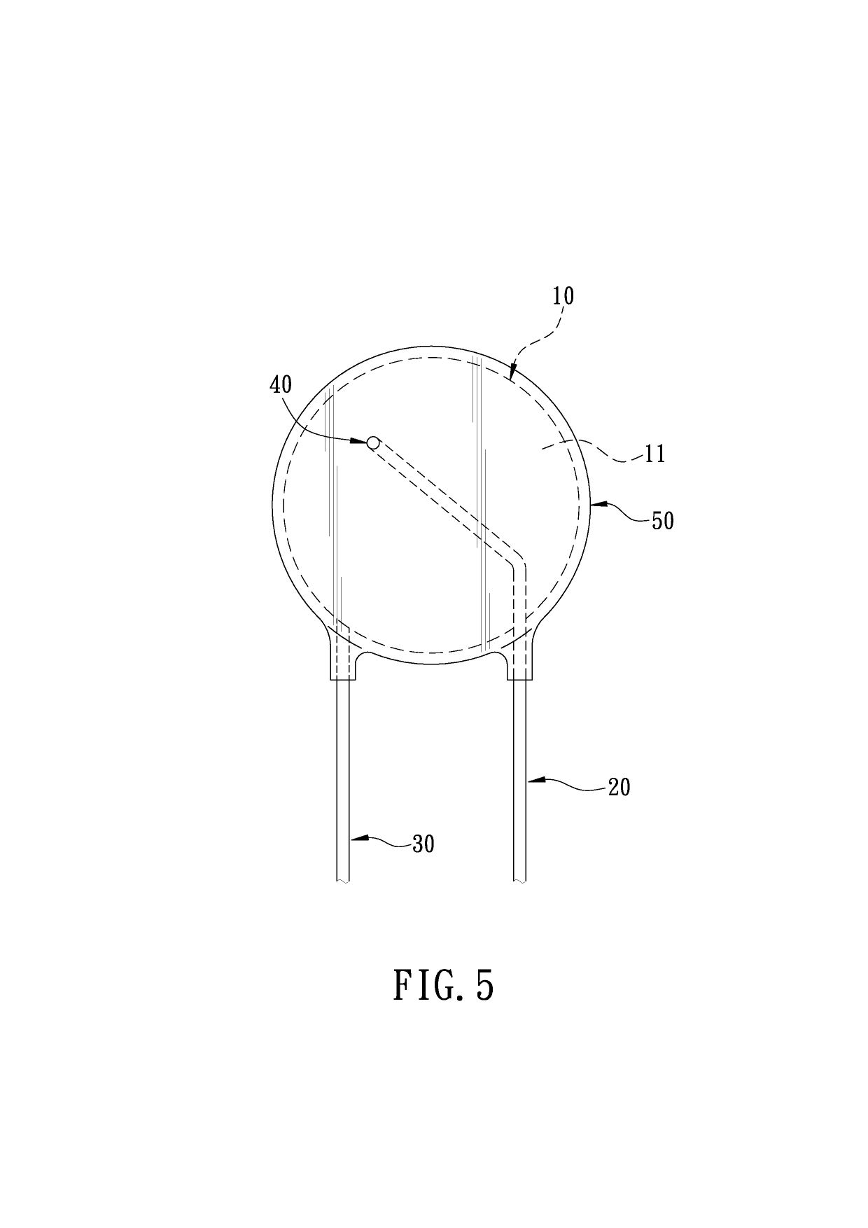

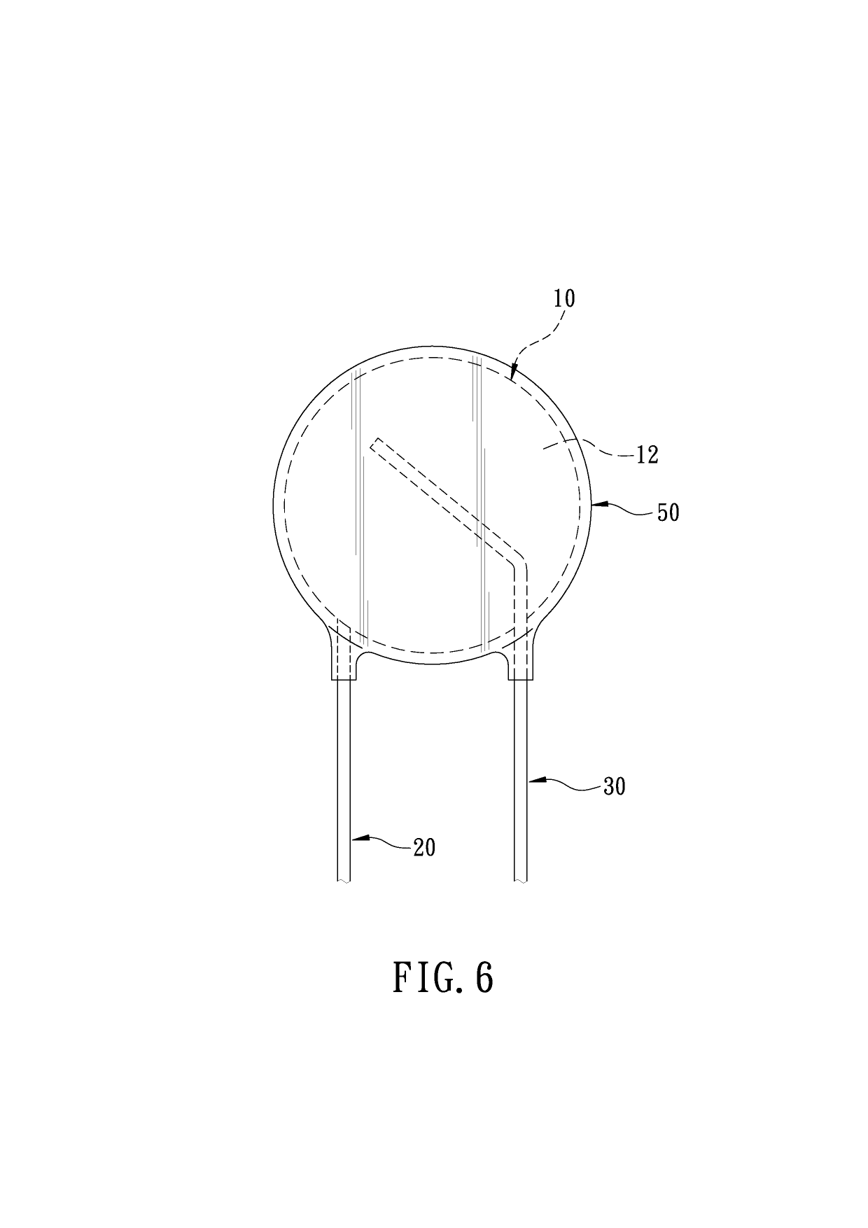

Referring to FIGS. 4, 5, and 6, a schematic view, a front view, and a back view of a first preferred embodiment of the present invention are shown. The present invention mainly comprises a body 10, a first lead-out electrode 20, a second lead-out electrode 30, a thermal energy guider 40 and a packing material 50.

Wherein, the body 10 adopts a VDR base as that of a conventional one, so the like technology is herein omitted.

The first lead-out electrode 20 is electrically connected to a first surface 11 of the body 10. In this embodiment, the first lead-out electrode 20 is made of a tin-plated copper wire.

The second lead-out electrode 30 is electrically connected to a second surface 12 of the body 10. In this embodiment, the second lead-out electrode 30 is made of a tin-plated copper wire.

The thermal energy guider 40 adopts a continuous leading wire and is electrically connected to the first lead-out electrode 20. In this embodiment, the thermal energy guider 40 is made of a tin-plated copper wire.

The packing material 50 wraps an appearance of the body 10. The first lead-out electrode 20, the second lead-out electrode 30, and the thermal energy guider 40 penetrate and are extended out of the packing material 50. In this embodiment, the packing material 50 is made of epoxy resin.

Accordingly, the protecting unit having the function of thermal energy guiding not only allows the body 10 to generate heat when surge current passes but also permits the thermal energy guider 40 to guide the thermal energy out. When the thermal energy guider 40 adopts a single and continuous metal to launch thermal conduction, the thermal energy generated by the body 10 could be correctly and efficiently guided out, so that the collocated over-heat protective unit, such as the TCO, is able to promptly sense the abnormal temperature and start. Additionally, when the packing material 50 wraps the body, the body 10 is prevented from aging and malfunctioning, thereby averting danger.

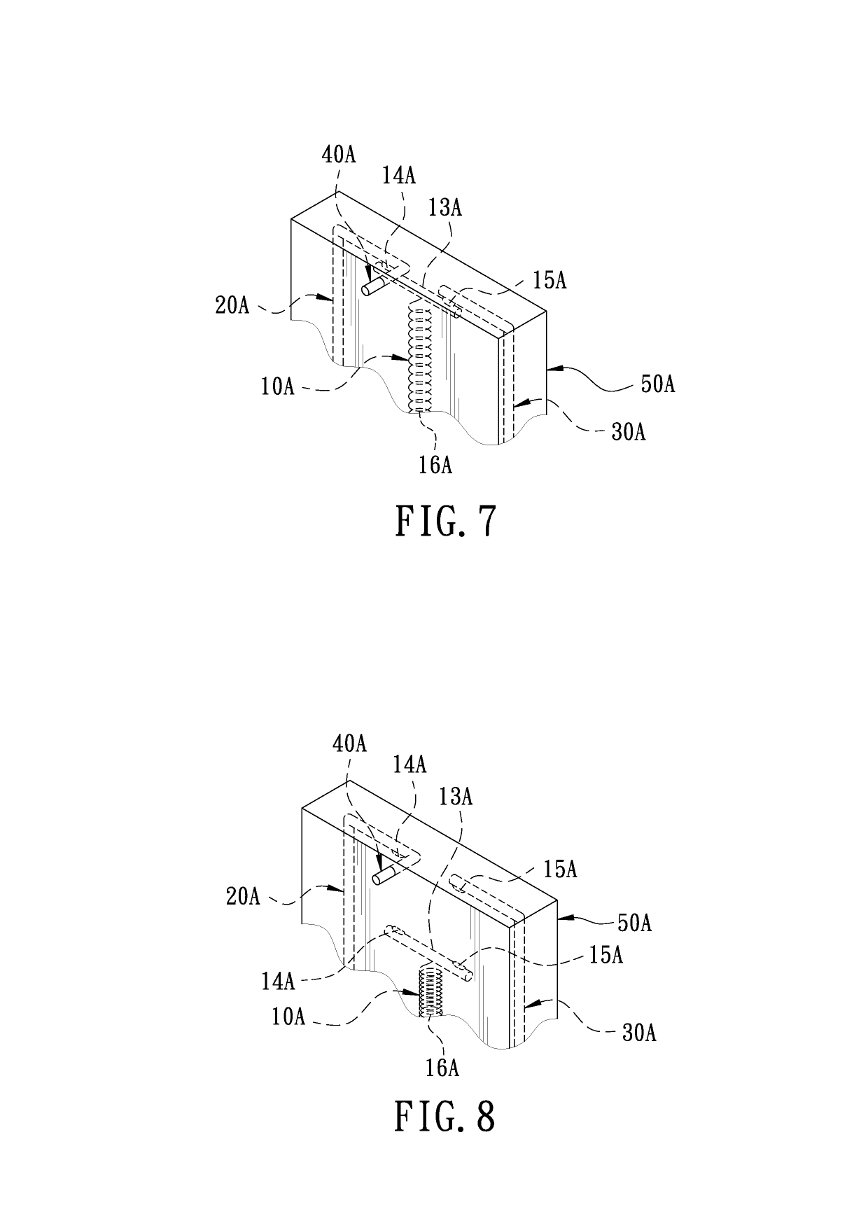

FIG. 7 shows a schematic view of a second preferred embodiment of the present invention, which mainly comprises a body 10, a first lead-out electrode 20A, a second lead-out electrode 30A, a thermal energy guider 40A, and a packing material 50A.

Wherein, the body 10A adopts a TCO in this embodiment, and the body 10A has a lead 13A which is made of tin-plated copper wire. Two ends of the lead 13A has a first alloy 14A having low fusing point and a second alloy 15A having low fusing point, respectively. An elastic member 16A is disposed at a middle bottom of the lead 13A. Herein, the elastic member 16A adopts a spring. Whereby, one end of the elastic member 16A is fixed to the lead 13A, and the other end of the elastic member 16A is fixed to the packing material 50A. As a result, a pulling force for disconnection is generated between the lead 13A and the first lead-out electrode 20A as well as the second lead-out electrode 30A.

The first lead-out electrode 20A is electrically connected to the first alloy 14A having low fusing point. Herein, the first lead-out electrode 20A is made of tin-plated copper wire.

The second lead-out electrode 30A is electrically connected to the second alloy 15A having low fusing point. Herein, the second lead-out electrode 30A is made of tin-plated copper wire.

The thermal energy guider 40A adopts a continuous leading wire whose one end is electrically connected to the first lead-out electrode 20A and the other end directly contacts or nearly-touches the protected unit to achieve the shortest response time. Herein, the thermal energy guider 40A is made of tin-plated copper wire.

The packing material 50A wraps the appearance of the body 10A. Herein, the packing material 50A adopts an insulating housing. The first lead-out electrode 20A, the second lead-out electrode 30A, and the thermal energy guider 40A respectively penetrate and extend out of the packing material 50A.

When the thermal energy generated from the electronic appliances is conducted to the body 10A from the thermal energy guider 40A, the first alloy 14A having low fusing point and the second alloy 15A having low fusing point in the body 10A receive the thermal energy and contribute to a melting state. Accordingly, FIG. 8 shows a schematic view that the current in the second preferred embodiment is cut off. Wherein, the melted first and second alloys are not connected anymore, and the elastic member 16A utilizes the elasticity thereof to promptly cut off the current. Herein, since the elasticity is an external and mechanical force, the alloy that has low fusing point does not easily remain. When afore mechanical disconnecting force is compared with that utilizes the surface tension and the particular material, a faster and proper disconnection is achieved for preventing leakage of electricity. Further, the packing material 50A wrapping the body 10A further prevents the body 10A from contacting exterior, gradually aging, and malfunctioning.

The present invention is not limited in the first preferred embodiment. Namely, the VDR base could be further electrically connected to the first lead-out electrode and the second lead-out electrode via the silver paste.

The present invention is also not limited in the second preferred embodiment. Namely, the length of the thermal energy guider could be further extended. Accordingly, the thermal energy generated in time of welding the body does not trigger the first alloy and the second alloy ahead. Preferably, the area of the first alloy and the second alloy could be increased so as to concurrently augment an overlapping area formed by the body and the first lead-out electrode as well as the second lead-out electrode. Whereby, differences between the electric conductivity of the metal materials are prevented, so correlated danger is also avoided. While the body is substituted by a combination of the alloy having low fusing point and the particular material, the reaction could be further speeded up.

I claim:

1. A protecting unit having a function of thermal energy guiding comprising:
a body electrically connected to a first lead-out electrode and a second lead-out electrode;
a thermal energy guider adopting a continuous leading wire;
one end of said leading wire being disposed on said first lead-out electrode, and the other end thereof being outward extended; and
a packing material wrapping an appearance of said body; said first lead-out electrode, said second lead-out electrode, and said thermal energy guider respectively penetrating and extended out of said packing material;
thereby, said thermal energy guider utilizing thermal conduction to guide thermal energy in/out of said body so as to prevent electronic appliances from overloading and avert danger.

2. The protecting unit as claimed in claim 1, wherein, said thermal energy guider adopts a tin-plated copper wire.

3. The protecting unit as claimed in claim 1, wherein, said body adopts a voltage dependent resistor (VDR) base which includes a first surface and a second surface disposed on two sides thereof, respectively; said first surface is electrically connected to said first lead-out electrode and said second surface is electrically connected to said second lead-out electrode.

4. The protecting unit as claimed in claim 3, wherein, said packing material adopts epoxy resin.

5. The protecting unit as claimed in clam 1, wherein, said body adopts a thermal cut-off (TCO); said body has a lead which includes a first alloy having low fusing point and a second alloy having low fusing point disposed on two ends thereof, respectively; said lead is electrically connected to said first lead-out electrode and said second lead-out electrode, respectively; an elastic member is disposed at a middle bottom of said lead on said body, which contributes to a pulling force between said lead and said first lead-out electrode as well as said second lead-out electrode for disconnection.

6. The protecting unit as claimed in claim 5, wherein, said packing material adopts an insulating housing.
